(19) United States
(12) Patent Application Publication
(10) Pub. No.: US 2007/0171237 A1
(43) Pub. Date: Jul. 26, 2007

(54) System for superimposing a face image on a body image

(76) Inventor: Marco Pinter, Santa Barbara, CA (US)

Correspondence Address: Marco Pinter, 445 Stanford Place, Santa Barbara, CA, 93111, US

(21) Appl. No.: 11/657,375

(22) Filed: Jan. 23, 2007

Related U.S. Application Data
(60) Provisional application No. 60/762,474, filed on Jan. 25, 2006.

(51) Int. Cl. G09G 5/00

(52) U.S. Cl. 345/629

(57) ABSTRACT

A software application, and associated systems and methods, for superimposing a face extracted from one digital image onto a body, human or otherwise, in a background scene image. The software application can be used on different platforms, such as a handheld communication device or a standard desktop computer. The software application allows digital compositing of certain features to a face image, such as hair styles, facial hair, hats and text.

### CROSS-REFERENCE TO RELATED APPLICATIONS

This application claims priority to U.S. Provisional application Ser. No. 60/762,474, filed Jan. 25, 2006

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

Many people find it very amusing and interesting to see their own faces, and those of their friends and family, on other bodies in different photographs. In this way they can imagine the individual as a movie star, a supermodel, a superhero, politician, etc. For similar reasons, people like to see themselves or friends with alternative hairstyles, facial hair, hats, jewelry, etc., and would appreciate the ability to add amusing text to images in the form of speech balloons, thought bubbles or captions.

Classically this sort of digital compositing has been done using the Adobe Photoshop application, and for this reason, the action of doing this to digital photographs is sometimes even called “photoshopping.” However, Photoshop is a very complex and somewhat expensive product, designed for all forms of general image manipulation, and is ill-suited for amateurs who want to quickly perform the above type of operations. Moreover, the complexity of the interface generally restricts Photoshop to installations with a full keyboard and mouse, and is therefore not suitable for use on platforms such as cell phones and PDA's.

A small number of other applications exist which try to provide more accessible digital composition, either as Web applications or standalone PC programs, for example Arcsoft Funhouse. However these suffer from overly limited capabilities which result in final composite images that are not nearly as fulfilling as they might otherwise be.

U.S. Pat. No. 4,823,285 discloses a method for representing a person with a modified hairstyle by means of a computer, a camera and a screen. Once a hairstyle has been selected from available choices, it is digitally composited on the original image of the person.

U.S. Pat. No. 6,307,568 discloses a method for trying on a garment by a user through a Web page on the Internet, involving choosing from available digital garment images and digitally compositing them onto the user's photograph.

U.S. Pat. No. 6,782,128 discloses a method of extracting a photographic image of a person's face and mapping it onto the head of a doll.

Unlike the above prior art, the software discussed herein utilizes innovative interface techniques which allow the operations to be accomplished quickly, intuitively and with highly rewarding results.

Additionally, there is a specific need for software designed to run on camera phones, which are now enormously popular, that incorporates the images taken by the device (or sent wirelessly from friends) and manipulating the images in an entertaining way. As applied to this invention, there is a need for camera phone software which allows users to extract the faces from one picture and digitally composite them onto another body; and also a need for software to add certain new features onto the photographs of faces, such features including hair styles, facial hair, hats, jewelry, humorous text, etc.

U.S. Pat. Nos. 6,677,967 & 6,970,177, from Nintendo, discloses a method for mapping a face onto 3D characters and manipulating the resultant in games, in a game console device. U.S. Pat Pending No. 20020082082 discloses a similar method for a portable game system. These references describe limited capabilities aimed at the particular interfaces of specific-purpose devices.

Unlike the above prior art, one form of the invention described here is specifically designed for handheld general purpose communication devices (like camera phones); using the photographs taken from embedded cameras in the device or sent from friends; manipulating them in ways that take specific advantage of the phone as an interface device; adding features to faces on this medium; and giving the option of sending the resultant image to friends via the phone.

### BRIEF SUMMARY OF THE INVENTION

This invention is an application for superimposing a part of an image, such as a face extracted from one digital image onto a scene such as a body, human or otherwise, in a background image. One embodiment described herein is a software application running on a handheld general purpose communication device. This application provides a novel platform-appropriate interface allowing for practical digital composition. Another embodiment described herein is a software application running on a standard desktop computer. In that environment, there are also a number of interface elements and technologies described which are new and unique.

The present invention, in various embodiments, comprises a software application that allows a user to extract a face image from a first photograph and paste the face image onto a scene, which may be a photograph or other rendering. Typically the scene is a photograph of a body. According to an aspect of the invention, a software application with these features is provided that can be loaded onto a general purpose handheld communications device such as a cell phone or PDA, or alternatively loaded on a computer. The images can be derived from a camera, which may be separate or integrated into a handheld communications device, or can be obtained via a wired or wireless communications link. On one embodiment, the software provides for automatic or manual flesh color matching between photograph and scene. In another embodiment, the software provides for face outlining with a solid color. In still another embodiment, the software provides paint brush features such as paint-with-face, paint-with-scene, and paint-with-background features.

Further embodiments, aspects, modes, features of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be described in more detail hereafter by means of exemplary embodiments.

FIGS. 1a, 1b and 1c schematically show exemplary types of handheld communication devices and input methods.

FIGS. 2a, 2b, and 2c schematically show category selection, thumbnail-based selection, and single image selection.

FIGS. 3a, 3b and 3c schematically show extracting a face.

FIG. 4 schematically shows positioning and resizing of a face.

FIG. 5 schematically shows adding of features.

FIG. 6 schematically shows the computer interface, illustrating the steps and scene selection.

FIG. 7 schematically shows selection of the face area.

FIG. 8 schematically shows painting and touch-up of the composite image.

### DETAILED DESCRIPTION OF THE INVENTION

### Embodiment I

### Handheld Communication Device

A specific application is described which runs on a handheld mobile communication device, to superimpose a digital face image on a digital body image. Devices can include, but are not limited to cell phones and camera phones. Note that some parts of the application, for example the actual superimposition of the face image on the body image, may occur on a central server, with the handheld device acting as an interface to send and receive information. Clearly other types of images or scenes could be manipulated in the same way as described in the following specific example, and such modifications are within the scope of the invention.

A. General Information

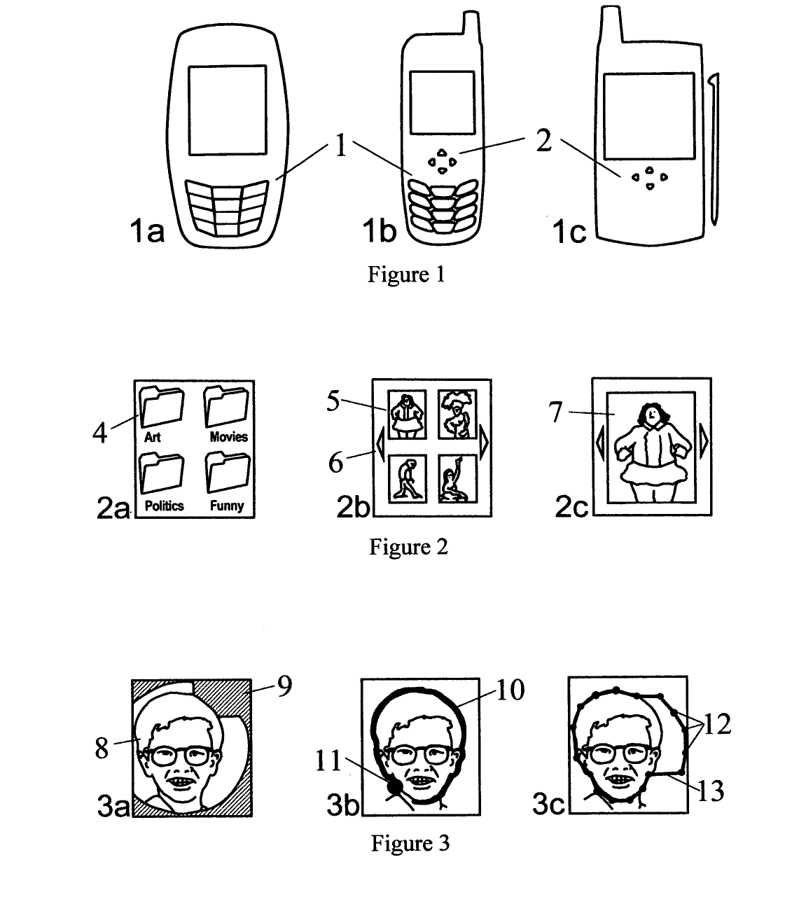

Within this section there are a number of references to using available input methods on the handheld device for user input. Handheld communications devices can vary greatly in available input methods as depicted in FIGS. 1a, 1b and 1c.

Some such as shown in FIG. 1a have number keys, 1, only; some as shown in FIG. 1b have arrow keys, 2; and some as shown in FIG. 1 c have some kind of pointing device, 3, such as a stylus, mouse thumb-stick or trackball. In this section, the term Available Selection Device (“ASD”) will refer to the following: number keys and/or arrow keys (if available) and/or a pointing device (if available.)

The user may wish to move to and select an on-screen button or interface element. If using number keys, there are two possibilities. First, the number keys could represent directions (i.e. 2=up, 8=down, 4=left, 6=right), in which case the user needs to move a visible highlight/outline to the element of choice, and then press a selection key (i.e. the number 5.) Alternatively, the interface elements could be labeled with numbers, in which the user simply needs to press the appropriate number.

If the input method is arrow keys, the user needs to move a visible highlight/outline to the element of choice using the arrows, and then press a selection key, typically located in the center of the arrows on the handheld device.

Finally, if the input method is a pointing device, the user can move that device up, down, left and right, and then “click” when at the selection of choice.

B. Method of Selecting a Background Scene/Body

An exemplary process of using the novel invention to select a background scene is illustrated in FIGS. 2a, 2b and 2c. First, the user will need to select a background image containing a body, human or otherwise, on which they will want to place their head. First, optionally, the user may be presented with a menu of categories, and optionally, sub-categories, to choose from. Possible categories could include Art, Political, and Movies. Sub-categories of movies could include Shrek, Star Wars, etc. If this option is utilized, the ASD is used to move between categories and sub-categories, and to select them, which may be in the form of on-screen folders 4 as shown in FIG. 2a.

Except in such case where only one background scene is available (for example under a certain sub-category), the user will need to select between multiple background scenes.

1. Thumbnails

In response to the category selection, thumbnail images 5 (small versions of either a whole background scene or some portion of it) may be laid out in a grid as shown in FIG. 2b. The ASD is used to highlight different thumbnails and eventually select one. If more images are available than fit on the screen, a method is required for seeing further choices. One method is to scroll the thumbnail grid right and left (or down and up) as the user either presses directional keys and/or pushes pointing device in the requisite direction. Alternatively, on-screen arrows 6 which move the grid right/left or down/up could be controlled by the ASD.

2. Single Images

Alternatively, the user may see only one background scene at a time 7 as shown in FIG. 2c. These can be scrolled through in the same manner described under Thumbnails above.

C. Method of Extracting the Face from a Digital Picture

During another step in the application process, the user will choose a photograph which pre-exists on their device. This photograph was likely acquired using a camera embedded in the handheld device, but alternatively may have been sent to the camera from another device.

Once an image is selected which contains the desired face, the portion of the image containing the face must be extracted. An exemplary process of extracting the face is shown schematically in FIGS. 3a, 3b and 3c:

1. Outlining the Face

As shown in FIG. 3a, the portion of the image around the face 8 which is to be excluded from the face extraction, is overlaid with a solid color) 9. Alternatively, as shown in FIG. 3b, the outline around the face can be shown with a bright or dark overlaid line 10. In either case, at any given moment there is a “cursor” 11 representing the outlining point, and any movement of that cursor causes the outline to be defined. The outline cursor can be moved directionally using number keys or arrow keys; or it can be moved smoothly using a pointing device.

2. Select and Move Waypoints Around The Face

Alternatively, as shown in FIG. 3C, the face is surrounded by a fixed number of moveable points 12, each one connected to the next by a line. The ASD is used to go from one point to the next, and move that point directionally until it just touches the edge of the face. In this fashion, an outline is defined by a polygon 13 around the face.

3. Automatic Face Detection Using Available Technologies

With this method, any of the various published face detection technologies can be employed or licensed in order to automatically detect the face area on the image containing it, and extract just the face.

4. No Extraction: Face Fits Within a Template

With this method, the background scene contains an oval “hole” where the face is to go. So when the face is being positioned (see Section (D) below), it is only visible through the oval. Hence, no outline needs to be extracted. This method is mutually exclusive of Section (E) below.

D. Position and Resize Face

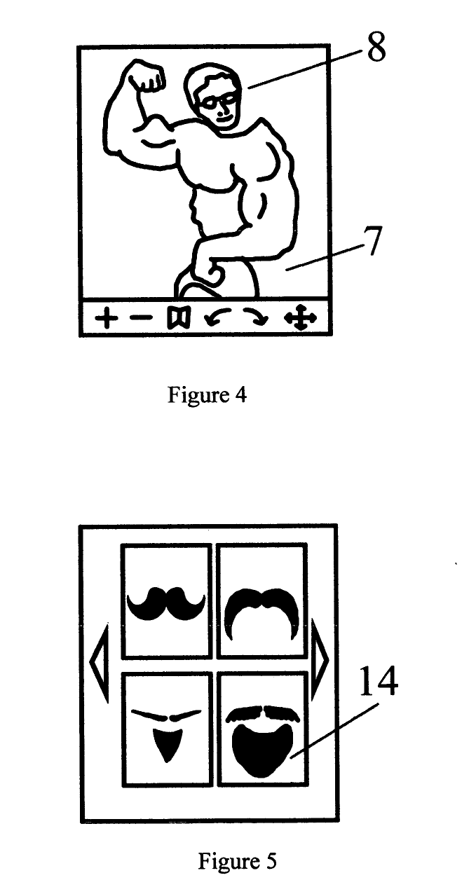

During this portion of the application, the user positions, rotates and resizes the face 8 to match the scene 7, as illustrated in FIG. 4 and described below:

1. Positioning: If number or arrow keys are being used, this is done with standard directional keying. If a pointing device is used, the face can be moved easily by pointing to the new location.

2. Resizing: Functions to make the face larger or smaller are available to the user either by (a) specific keys, e.g. “1,” for smaller and “2” for bigger, or (b) on-screen enlarge and contract buttons which the user can select with the ASD.

3. Rotating: Functions to rotate the face left or right are available in a similar way to the Resizing functions.

An additional optional function can be important for making quality superimposed images. A button would allow the face to be mirrored. In an ideal embodiment, the mirroring is done around the current axis of face rotation, as defined by previous rotations.

Note that in one embodiment, the background image may in fact have some animation. In such case, if the body on the background moves, the new positions of the superimposed face can easily be calculated based on known vectors of movement in the background body.

E. Remove Background Face on Approach

This is an optional feature, which may or may not be included in the application. Since the background scenes come from a library, the library could also include a version of each scene image with all the heads removed. Utilizing the ASD, the new face would be positioned. As the new face approaches a head on the original image, the original head will disappear, being replaced by the head-removed background image in that location.

Optionally, hair and facial hair from the background face can remain as an overlay on the new face.

F. Auto-Flesh Color Matching

This feature would either occur automatically, or after selected by a user.

An algorithm examines those pixels of the face which were on the background image, which are “underneath” where the new foreground face image is placed. It then does analysis and computes histograms to determine the brightness, contrast and relative color shift (i.e. in RGB space) of that group of pixels. The same analysis is computed for the pixels of the foreground face. Finally, the pixels of the foreground face are modified to have a similar color shift, brightness and contrast as the background face.

Optionally, application of this feature can be followed by an interface which allows the user to manually “tweak” the brightness, contrast, and color-shift values until finding a match they deem best.

G. Alternative to Custom Face: Select a Pre-Defined Face From a Menu of Faces

As an alternative to the user selecting a face image of their own, some embodiments of the application may allow the user to select from a library of pre-existing face images. The selection process would analogous to that described in Section (B) above. While perhaps being less interesting to some, this alternative has the advantage of not requiring any face extraction. Instead, all faces would already be pre-outlined in the database library, ready for positioning on a background. Further, optionally, optimal auto-flesh values could be pre-computed for every available face and body image, and also stored in the database.

H. Final Touches

Add facial hair; hats; animate head; thought/speech balloons.

Referring to FIG. 5, as a final step, optionally, the user may be presented with an interface allowing a choice of additional overlays 14, such as facial hair, hats, jewelry, and/or thought or speech bubbles/balloons to designate what people are saying or thinking. The overlays would be laid out in a grid. Either all overlays would be seen simultaneously, and laid out organizationally, i.e. all moustaches together, or alternatively, a prior menu layer would allow the user to select the type of overlay, and then see a grid of just those types. In either case, if more overlays exist than fit on the screen, the user can advance through others just as described for background scenes in Section (B).

Individual items would be selected with the ASD, and then positioned, resized and rotated just as the face was handled in Section (D) above.

In addition, the user may be given the option to animate the head, e.g. a comical bobbing back and forth, perhaps to accompanied music.

I. Store or Send Result

Optionally, an embodiment may include options at the end for the user to store the resultant image on their device, or send it to another device, e.g. a friend's phone or email address.

### Embodiment II

### Personal Computer Application

An application is described which runs on a standard personal computer or game console, to superimpose a digital face image on a digital body image.

A. Sequence of Linear Steps

A user proceeds through the application in a linear sequence of steps, which may be indicated on a horizontal or vertical bar in the interface, with the current step highlighted in some fashion.

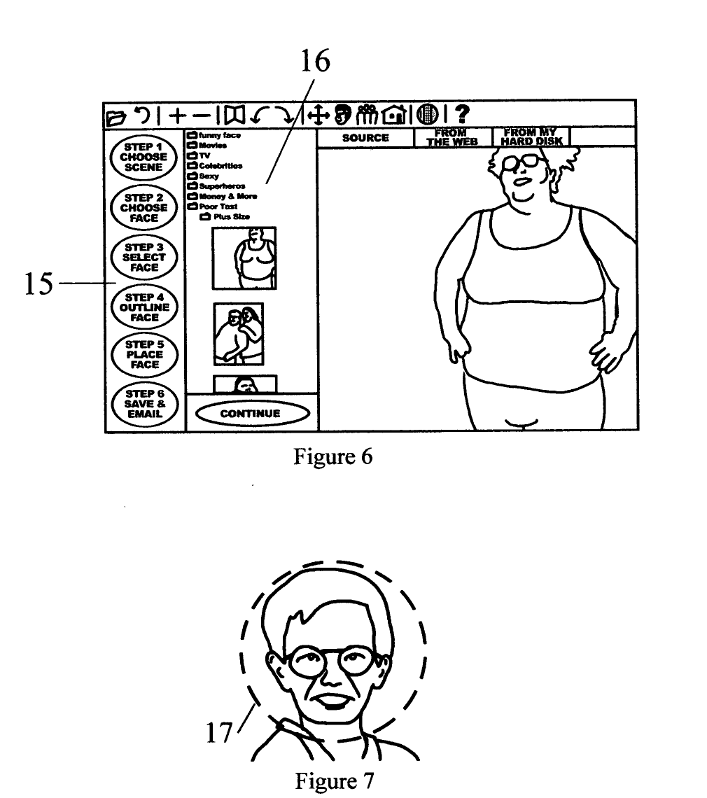

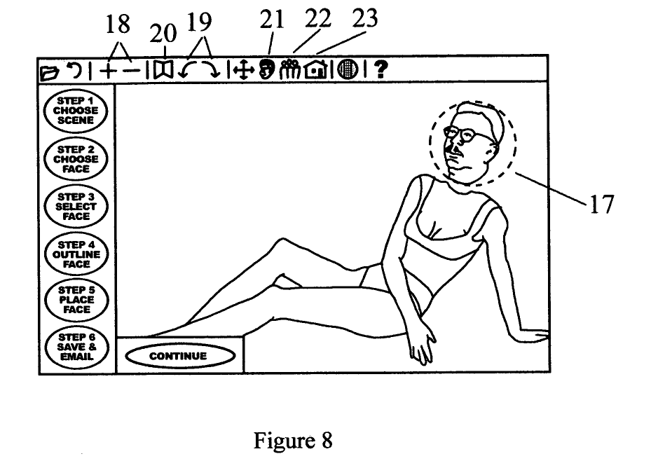

As illustrated in FIG. 6, the steps are listed vertically on the left of the interface 15. The first step involves choosing a background scene; the second step allows the user to choose the image containing the desired face; the third step allows the user to select the portion of the image containing the face; the fourth step allows the user to outline the face; the fifth step allows for positioning and sizing of the face on the background scene, as well as general touch up; and the final step allows for saving or emailing the resultant image.

Note that in other embodiments, certain steps may be re-ordered. For example, the background scene could be chosen first, then the face chosen, selected and outlined. Also, a step may be inserted for adding text, hair, hats, etc., as described in Section (F) below.

B. Thumbnail Library for Choosing Background Scenes

An important part of the interface is the selection of a background scene. In some embodiments, the user may only be able to load scenes from their hard drive, which would be done using a standard Open File dialog box. In a preferred embodiment, the user can choose between images on their hard drive or those in a library. (Alternatively, an embodiment could only allow scenes from a pre-existing library.)

The library selection 16 is done via a tree view of categories, sub-categories and thumbnail images. So, for example, a user might click on the “Political” folder, then see several folders of sub-categories, and click on “Arnold Schwarzenegger”, and then see a series of thumbnails of the California governor. Clicking on a thumbnail will preview it in the large view.

Alternatively, library scene selection can be accomplished by optionally first selecting a category (and possibly sub-category), then viewing a grid or list of thumbnails, with some method of scrolling through more if the list exceeds the window size. All these methods are described under I(A) above in the handheld device section.

C. Method of Face Selection

In this embodiment, face selection is handled in two steps. First, while viewing the image containing the face, the user drags and drops a circular (or oval) selection area 17 of FIG. 7 over the portion of the face they desire. The size of the selection area can be increased or decreased by clicking buttons, and/or grabbing the edge of the selection area with the mouse and dragging it in or out.

In the next step, the user is presented with the circular (or oval) portion of the face they just selected. Now the user draws with the cursor around the face. The portion of the image which is not to be used is shown to the user as a solid magenta (or other color) indicating eventual transparency over the background scene.

Alternatively, other embodiments allow face selection by moving waypoints or by automatic face detection, as described in I.(B).2, 3 above.

D. Painting Face, Background and Scene, Mirroring.

As shown in FIG. once the background scene and face have been fully selected, the user proceeds to the step where they position, rotate and resize the face. These functions are fairly standard. Buttons on the toolbar allow for decreasing or increasing the size of the face, 18, and rotating the face left or right, 19. The face is moved by clicking inside the selection area 17 (possibly when a “move” mode button is toggled on the toolbar) and dragging. Alternatively or in addition to the resize buttons, some embodiments may allow the face to be resized by clicking on the outline and dragging it inward or outward.

An additional function is often crucial for making quality superimposed images. A button 20 allows the face to be mirrored. In an ideal embodiment, the mirroring is done around the current axis of face rotation, as defined by previous rotations.

A highly unique set of features of this invention are the simple touch-up paint brushes. There are three kinds:

1. Face brush: Selecting this brush 21 allows the user to paint pixels from the face image onto the final image. This means that if the user perhaps cropped too much of the ear during the previous selection step (or when using one of the other brushes below), they can paint the ear back with this brush. Optionally this brush may come in multiple sizes, as would the next two as well.

2. Scene brush: Selecting this brush 22 allows the user to paint pixels from the original scene image. Perhaps they didn't crop away enough of the neck in the previous step, so they can paint from the neck which is “underneath” using this brush. Or if they want a beard from the original scene image superimposed on their new face, they can paint it back in with this brush.

3. Background brush: For background scenes that came from a pre-existing library (and not the users hard drive), the library also includes a version of each scene image with all the heads removed. So using this brush 23 allows users to paint with pixels that would have been “behind” the face on the background scene. For example, let's say the original background face had a very long nose in profile. So when the user places the new face on top, a portion of the old nose is still protruding. Using the background brush, they can erase that portion of the nose.

Optionally, during this step, the background face can be removed on approach, as described in Embodiment I, Section (E), provided the background scene came from a preexisting library.

E. Auto-Flesh Color Matching

See Embodiment I, Section (F) for details.

F. Final Touches

Add facial hair; hats; animate head; thought/speech balloons.

See Embodiment I, Section (H) for details, except that instead of using the ASD for selection, in this case the mouse is used to select the desired items and then position them on the picture.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art. In the appended claims, reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present invention. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A software application running on a handheld communications device, comprising:
an interface with input from at least one selection device,
a function to allow a user to extract a face image from a photograph; and,
a function to allow the user to paste the face onto a scene, whereby a composite image is formed.

2. The application of claim 1 wherein the face image is derived from an embedded or attached camera on the handheld communications device.

3. The application of claim 1 wherein the face image is acquired remotely via a wireless communications link.

4. The application of claim 1 wherein the scene is a second photograph.

5. The application of claim 1 wherein the scene is a body.

6. The application of claim 1 further comprising a function wherein the scene can be chosen from many possible scenes; and in the case where only one or a few available scenes are viewable on-screen out of the larger palette of available scenes, the palette can be scrolled through via the selection device on the handheld communications device.

7. The application of claim 1 wherein the selection device may be one or more of;
number keys,
arrow keys; or,
physical pointing devices.

8. The application of claim 1 wherein the extraction function comprises a selection function which includes at least one of;
selection via outline with a solid color that radiates outward from the outlining point, or selection via multiple user placed waypoints around the face which collectively form an outline.

9. The application of claim 7 further comprising a function to allow the user to select at least one of position, sizing, or rotation parameters of a selected portion of the image with the selection device(s), then use the selection device(s) to change the selected parameter.

10. The application of claim 5 further comprising a flesh color matching function wherein an average color of a color sampled set of pixels from the covered-up face area of the body is applied to the face area of the face image.

11. The application of claim 1 further comprising special paint tools to allow users to paint on the composite image with pixels from other source images.

12. The application of claim 1 further comprising special paint tools to allow users to paint from pixels from either the photograph or the scene in order to touch up the edges in the composite image.

13. The application of claim 1 further comprising special paint tools to paint over the composite image with pixels from a second scene to touch-up and remove any jutting-out pixels wherein the application already has available the second scene which is a derivation of the original scene in which faces or whole bodies are removed.

14. The application of claim 1 further comprising a function wherein features may be added to the composite image.

15. The application of claim 1 wherein the resultant composited image, or an animation derived from said composited image, can be wirelessly sent to other handheld communication devices.

16. A software application running on a handheld communications device, comprising;
an interface with input from at least one selection device; and,
a function to allow a user to add features to a photograph of a face.

17. The application of claim 16 wherein the face photograph is derived from an embedded or attached camera on the handheld communications device.

18. The application of claim 16 wherein the face photograph is acquired remotely via a wireless communications link.

19. The application of claim 16 further comprising a function wherein the features can be chosen from many possible features; and in the case where only one or a few available features are viewable on-screen out of the larger palette of available features, the palette can be scrolled through via the selection device on the handheld communications device.

20. The application of claim 16 wherein the selection device may be one or more of;
number keys,
arrow keys; or,
physical pointing devices.

21. The application of claim 15 wherein features optionally include facial hair, hats, jewelry and text.

22. The application of claim 20 wherein the resultant composited image, or an animation derived from said composited image, can be wirelessly sent to other handheld communication devices.

23. A software application comprising a function to allow a user to extract a face image from a photograph and paste it onto a body photograph, including an automatic flesh color matching operation wherein an average color of a color sampled set of pixels from the covered-up face area of the body is applied to the face area of the face image.

24. A software application comprising;
a function to allow a user to extract a face image from a photograph,
a function to allow the user to paste the face image onto scene to form a composite image; and,
paint tools to allow the user to paint on the composite image with pixels from other source images.

25. The application of claim 24 wherein the paint tools allow the user to paint from pixels from either the face photograph or the scene in order to touch up the edges in the composite image.

26. The application of claim 24 further comprising special paint tools to paint over the composite image with pixels from a second scene to touch-up and remove any jutting-out pixels wherein the application already has available the second scene which is a derivation of the original scene in which faces or whole bodies are removed.

27. A software application comprising a function to allow a user to extract a face image from a photograph and paste it onto a scene, wherein the function allows for selection of the face via an outline with a solid color that radiates outward from an outlining point.
